(19) United States
(12) Patent Application Publication
(10) Pub. No.: US 2010/0180334 A1
(43) Pub. Date: Jul. 15, 2010

(54) NETWROK APPARATUS AND METHOD FOR TRANSFERING PACKETS

(76) Inventors: Jy Shyang CHEN, Cupertino, CA (US); Hui YANG, Wuhan (CN); Yu ZHAO, Wuhan (CN)

Correspondence Address: PATENT PROSECUTION;O2MIRCO , INC., 3118 PATRICK HENRY DRIVE, SANTA CLARA, CA, 95054, US

(21) Appl. No.: 12/685,834

(22) Filed: Jan. 12, 2010

Related U.S. Application Data
(60) Provisional application No. 61/144,858, filed on Jan. 15, 2009.

(51) Int. Cl. G06F 21/20

(52) U.S. Cl. 726/13

(57) ABSTRACT

A network apparatus cluster for transferring multiple packets of a communication session to a network node includes a primary unit and a subordinate unit coupled together. The primary unit is operable for receiving the packets comprising a first packet and multiple subsequent packets, for generating a session data set indicating the communication session and a balance data set based on the first packet, and for determining that the subsequent packets belong to the communication session according to the session data set. The balance data set indicates whether the first packet is distributed to the primary unit or the subordinate unit. The subsequent packets are transferred from the primary unit to the network node according to the balance data set.

### RELATED APPLICATION

This application claims priority to U.S. Provisional Application No. 61/144,858, titled “Hardware-Accelerated Embedded Firewall Load Balancer”, filed on Jan. 15, 2009, which is hereby incorporated by reference in its entirety.

### BACKGROUND

A firewall in a computer system or network is capable of blocking unauthorized access and permitting authorized communications. In computer networking, load balancing is a technique to distribute workload among two or more firewalls, in order to get enhanced resource utilization, enhanced throughput, and reduced response time, etc. The load balancing service can be provided by a dedicated hardware device such as a load balancer or a router.

FIG. 1 shows a diagram of a conventional network system 100. The network system 100 includes load balancers 102 and 104 coupled to the firewalls 106 and 108. The load balancers 102 and 104 can balance traffic between the firewalls 106 and 108 to prevent one firewall from passing an inordinate amount of traffic. However, the load balancers 102 and 104 may increase the cost of the network system 100. In addition, the firewall 106 or 108 can include a state table to allow a state based function. The state table stores session information relating to existing communication sessions, e.g., between the Internet 110 and local area networks (LANs) 122 and 124. By retrieving the state table, the firewall 106 or 108 can permit access to a received packet if the received packet belongs to an existing communication session. The load balancer 102 or 104 implements load balancing algorithms on each received packet and determines whether to distribute a received packet to the firewall 106 or 108. Thus, the data packets of the same communication session may be distributed to different firewalls, and the efficiency of the network system 100 may be decreased.

FIG. 2 shows another diagram of a conventional network system 200. The network system 200 includes routers 210 and 212 that support virtual router redundancy protocol (VRRP). The routers 210 and 212 can perform load balancing between the firewalls 206 and 208. The gateway addresses of the routers 210 and 212 are configured, e.g., according to settings of users, such that a router can transfer the packet to a designated firewall. For example, the router 210 can be configured to transfer packets to the firewall 206, and the router 212 can be configured to transfer packets to the firewall 208. Once the gateway addresses are settled, the path of packet flowing is fixed. In other words, the routers may need to be reconfigured to change the paths of packet flowing. Consequently, the load balancing for the firewalls 206 and 208 may lack flexibility. Moreover, the load balancing may not be implemented if the routers are unavailable.

### SUMMARY

In one embodiment, a network apparatus cluster for transferring multiple packets of a communication session to a network node includes a primary unit and a subordinate unit coupled together. The primary unit is operable for receiving the packets comprising a first packet and multiple subsequent packets, for generating a session data set indicating the communication session and a balance data set based on the first packet, and for determining that the subsequent packets belong to the communication session according to the session data set. The balance data set indicates whether the first packet is distributed to the primary unit or the subordinate unit. The subsequent packets are transferred from the primary unit to the network node according to the balance data set.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a diagram of a conventional network system.

FIG. 2 shows another diagram of a conventional network system.

FIG. 3 illustrates a diagram of a network system, in accordance with one embodiment of the present invention.

FIG. 4 illustrates a diagram of a firewall cluster, in accordance with one embodiment of the present invention.

FIG. 5 illustrates a flowchart of operations performed by a firewall cluster, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “generating,” “determining,” “transferring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present disclosure provide a network system having a network apparatus cluster, e.g., a firewall cluster. The firewall cluster includes a primary unit and one or more subordinate units. The primary unit includes a firewall module, a load balance module, and a session module. When a first packet of a communication session arrives at the firewall cluster, the firewall module of the primary unit can inspect the first packet and can generate a session data set indicating the corresponding communication session. The load balance module can determine whether to distribute the first packet to the primary unit or to a subordinate unit in order to balance the traffic between the primary unit and the subordinate unit. The load balance module can generate a balance data set indicating the load balancing, e.g., indicating whether the first packet in a corresponding communication session is distributed to the primary unit or a subordinate unit.

When subsequent packets of the same communication session arrive at the firewall cluster, the session module of the primary unit can determine that the subsequent packets belong to the communication session according to the session data set. Advantageously, the subsequent packets are transferred according to the corresponding balance data set. If the corresponding balance data set indicates that the first packet in a communication session is distributed to the subordinate unit, the subsequent packets in the same communication session are also transferred to the subordinate unit. As a result, the packets in the same communication session can be transferred through the same firewall, and thus the efficiency of the network system can be improved.

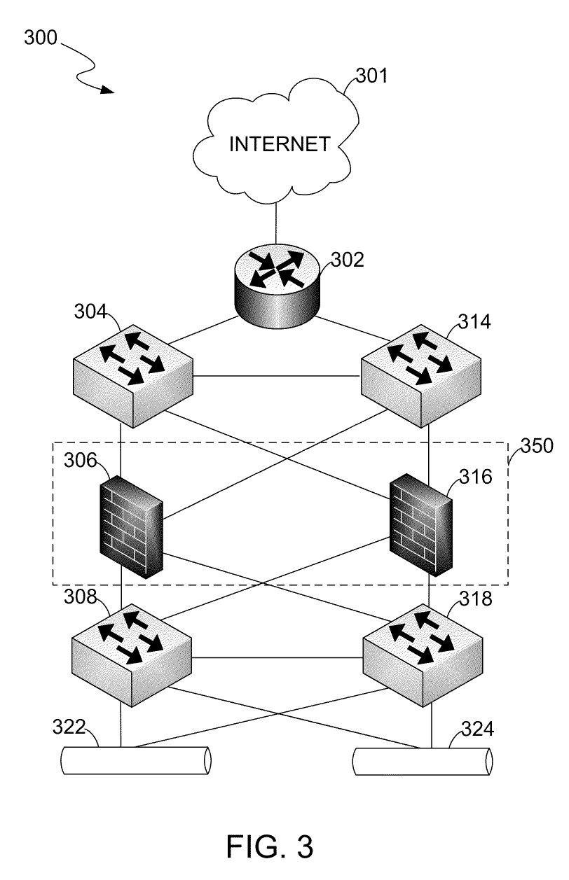

FIG. 3 illustrates a diagram of a network system 300, in accordance with one embodiment of the present invention. The network system 300 includes the Internet 301, a router 302, wide area network (WAN) switches 304 and 314, a firewall cluster 350, local area network (LAN) switches 308 and 318, and LANs 322 and 324. In one embodiment, the network system 300 can have a high availability (HA) topology, in which two devices can be backup devices for each other. In the example of FIG. 3, the firewall cluster 350 can include firewalls 306 and 316. When the firewall 306 is used as a working device, the firewall 316 can serve as a backup device for the firewall 306, and vice versa.

Data packets in a communication session can be transferred from the Internet 301 through the router 302 and the WAN switches 304 and 314 to the firewall cluster 350, and then through the LAN switches 308 and 318 to the LANs 322 and 324. Data packets in a communication session can also be transferred from the LANs 322 and 324 through the LAN switches 308 and 318 to the firewall cluster 350, and then through the WAN switches 304 and 314 and the router 302 to the Internet 301. In one embodiment, the firewall 306 can be a primary firewall (referred herein as a primary unit 306), and the firewall 316 can be a subordinate firewall (referred herein as a subordinate unit 316). A network address, e.g., a media access control (MAC) address, of the primary unit 306 can be used as a virtual network address of the firewall cluster 350. As such, the traffic from the WAN switches 304 and 314 or from the LAN switches 308 and 318 can be transferred to the primary unit 306 first, in one embodiment.

A communication session can include multiple data packets. The packets can be transferred one by one. The primary unit 306 can inspect a first packet of a communication session and can generate a session data set indicating the corresponding communication session associated with the first packet. Advantageously, the primary unit 306 can also balance the traffic between the primary unit 306 and the subordinate unit 316 by determining whether to distribute the first packet to the primary unit 306 or to the subordinate unit 316. The primary unit 306 can generate a balance data set according to the first packet. The balance data set can indicate whether the first packet is distributed to the primary unit 306 or the subordinate unit 316. As such, when a subsequent packet in the same communication session is received, the primary unit 306 can identify the communication session if the subsequent packet matches to the session data set associated with the first packet in the same communication session. The primary unit 306 can transfer the subsequent packet according to the corresponding balance data set. In one embodiment, if the balance data set indicates that the first packet in a communication session is distributed to the primary unit 306, all the subsequent packets in the same communication session are also transferred to the primary unit 306. The primary unit 306 can further inspect or analyze the contents of the communication session by linking all the packets together. If the balance data set indicates that the first packet in a communication session is distributed to the subordinate unit 316, all the subsequent packets in the same communication session are also transferred to the subordinate unit 316. The subordinate unit 316 can inspect or analyze the contents of the communication session by linking all the packets together. Therefore, the packets in the same communication session can be distributed to a same firewall unit, which can improve the efficiency of the firewall cluster 350.

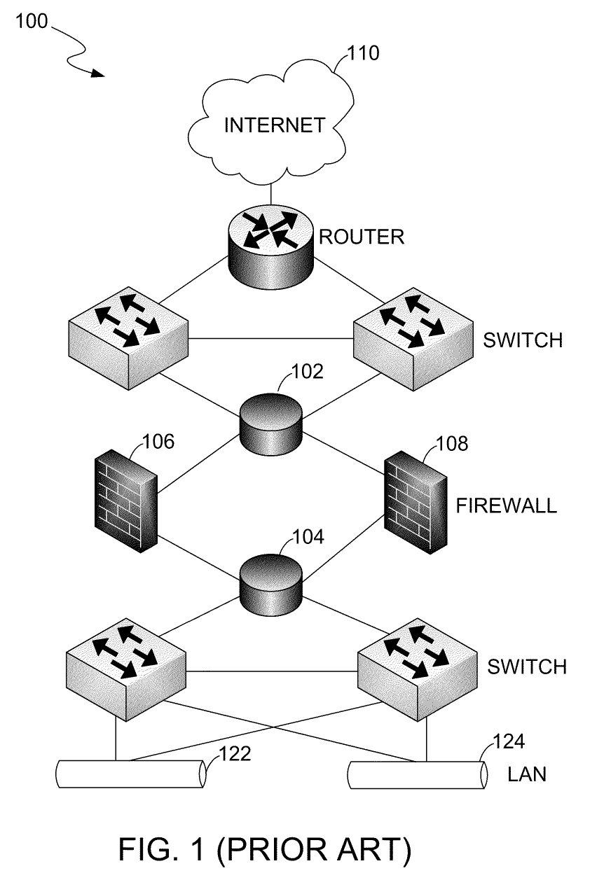

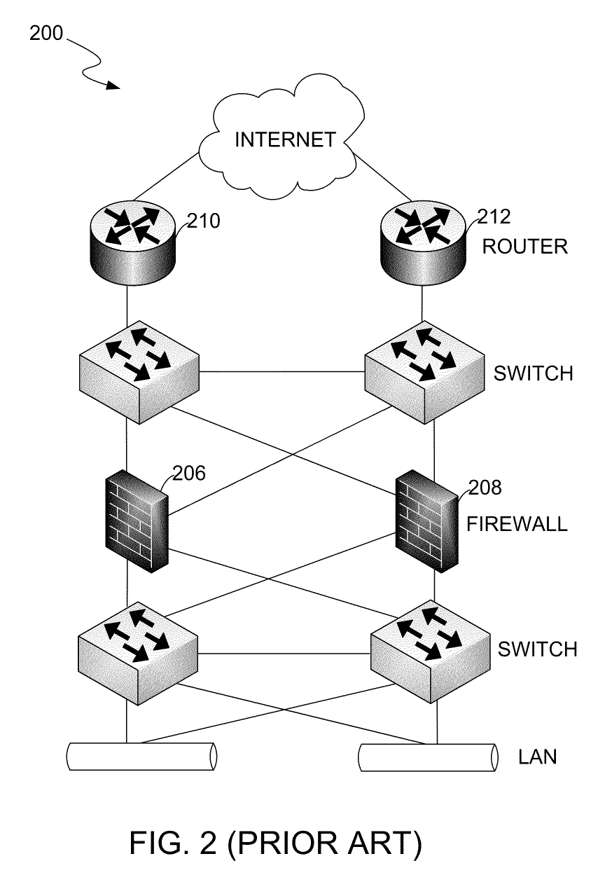

Advantageously, as the primary unit 306 has embedded load balancing function, the extra load balance devices, e.g., the load balancers 102 and 104 in FIG. 1 or the VRRP routers 210 and 212 in FIG. 2, can be removed. The firewall cluster 350 without such extra load balance devices can be adapted to many network topologies. Moreover, the cost of the network system 300 can be reduced.

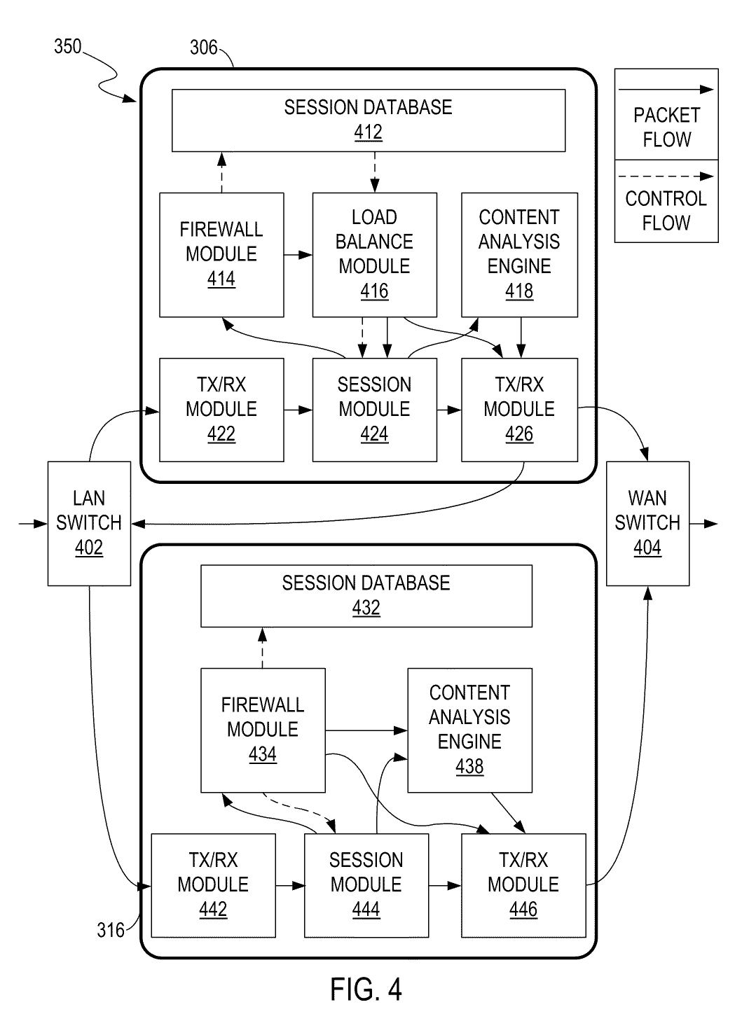

FIG. 4 illustrates a diagram of a firewall cluster 350, in accordance with one embodiment of the present invention. FIG. 4 is described in combination with FIG. 3. Elements labeled the same as in FIG. 3 have similar functions. In the FIG. 4 embodiment, a LAN switch 402 can represent the LAN switch 308 or 318 of FIG. 3. A WAN switch 404 can represent the WAN switch 304 or 314 of FIG. 3. Moreover, the solid arrow shows transferring of the data packets. The dotted arrow shows the control flow, e.g., transferring of the session data set and/or the balance data set. In the example of FIG. 4, the firewall cluster 350 includes the primary unit 306 and the subordinate unit 316. However, the firewall cluster 350 may include other number of subordinate units co-operating with the primary unit 306 to implement load balancing.

In one embodiment, the primary unit 306 includes a session database 412, a firewall module 414, a load balance module 416, a content analysis engine 418, transmitter/receiver (TX/RX) modules 422 and 426, and a session module 424. The components in the primary unit 306 can be software modules stored in a machine-readable medium or hardware modules such as integrated circuits. The TX/RX modules 422 and 426 are used for receiving and sending packets. For example, packets of a communication session are sent from the LAN switch 402 to the WAN switch 404. Since the MAC address of the primary unit 306 can be used as the virtual MAC address of the firewall cluster 350, the packets can be sent to the TX/RX module 422 of the primary unit 306.

A packet can be a formatted unit of data represented by a sequence of bytes, characters, or bits, and includes a header followed by a body. The header contains source and destination information of the packet. For example, the header can include source and destination internet protocol (IP) addresses, source and destination port numbers, protocol type, etc. The body contains data to be transmitted.

The session module 424 has a session table for storing multiple data sets associated with multiple communication sessions respectively. Each data set can include a session data set and a balance data set. A session data set includes session information, e.g., source and destination IP addresses, source and destination ports, and a protocol type, of a corresponding communication session. The session module 424 can identify the communication session to which a packet belongs by comparing the packet with the session data sets. More specifically, the session module 424 inspects a header of the received packet, e.g., the session module 424 compares the source and destination internet protocol (IP) addresses, the source and destination ports, and the protocol type contained in the header to the session data sets. If the received packet matches to the session data set of one of the data sets, e.g., the source and destination IP addresses, the source and destination ports, and the protocol type of the received packet match to the session data set of one of the data sets, the session module 424 can determine that the received packet is a subsequent packet of a corresponding existing communication session. If the received packet does not match to any session data set, the session module 424 can determine that the received packet is a first packet of a new communication session. Thus, the session module 424 sends the first packet to the firewall module 414 in the primary unit 306 for processing, in one embodiment.

The firewall module 414 is operable for filtering the packet, e.g., the first packet of a new communication session. For example, the firewall module 414 can permit, deny, encrypt, decrypt, or proxy computer traffic according to multiple filtering rules. If the first packet is authorized according to the filtering rules, e.g., the first packet belongs to an authorized communication session, the firewall module 414 can generate a session data set indicating the corresponding communication session associated with the first packet. The firewall module 414 stores the session data set to the session database 412, and sends the packet to the load balance module 416, in one embodiment.

The load balance module 416 implements load balancing on the first packet to determine which unit will be assigned to process the packet to balance the traffic between the primary unit 306 and the subordinate unit 316 and to prevent either unit from passing an inordinate amount of traffic. In one embodiment, if the load balance module 416 determines to distribute the first packet to the primary unit 306, the load balance module 416 can send the first packet to the TX/RX module 426. The TX/RX module 426 forwards the first packet to the WAN switch 404. Alternatively, the load balance module 416 can send the first packet to the session module 424. The session module 424 further transfers the first packet to the content analysis engine 418 for further inspection or analysis. In one embodiment, the primary unit 306 can determine whether to send the first packet to the content analysis engine 418 according to policies predefined by users.

If the load balance module 416 determines to distribute the first packet to the subordinate unit 316, a source MAC address of the first packet is changed to a MAC address of the primary unit 306. Moreover, a destination MAC address of the first packet is changed to a MAC address of the chosen subordinate unit 316. Then, the load balance module 416 sends the first packet to the TX/RX module 426. The TX/RX module 426 can send the first packet to the LAN switch 402. The LAN switch 402 can forward the first packet to the subordinate unit 316 according to the changed source and destination MAC addresses.

The load balance module 416 can also generate a balance data set indicating a result of the load balancing, e.g., whether the first packet is assigned to the primary unit 306 or the subordinate unit 316. The load balance module 416 can read the corresponding session data set stored in the session database 412, and can store a data set including the session data set and the balance data set in the session table of the session module 424. In one embodiment, the load balance module 416 updates the session table of the session module 424, e.g., stores the corresponding data set including the session data set and the balance data set in the session table of the session module 424, each time when a first packet of a new communication session is received.

If the received packet matches to the session data set of one of the data sets in the session table of the session module 424, the session module 424 can determine that the received packet is a subsequent packet of an existing communication session. In this instance, the session module 424 does not transfer the subsequent packet to the firewall module 414 and the load balance module 416. Instead, the session module 424 can transfer the subsequent packet according to the corresponding balance data set.

For example, if the balance data set indicates that the load balance module 416 distributes the first packet in an existing communication session to the primary unit 306, the session module 424 can transfer the subsequent packet in the same communication session to the TX/RX module 426. The TX/RX module 426 further transfers the subsequent packet to the WAN switch 404. Alternatively, the session module 424 can transfer the subsequent packet to the content analysis engine 418 for further inspection or analysis according to the policies predetermined by users.

If the balance data set indicates that the load balance module 416 distributes the first packet in an existing communication session to the subordinate unit 316, the session module 424 can forward the subsequent packet in the same communication session to the subordinate unit 316 in a similar way as the first packet. Advantageously, by detecting the session data set and the balance data set associated with the first packet of a communication session, the subsequent packets in the same communication session can be distributed to the same firewall unit as the first packet. As such, the efficiency of the network system 300 can be improved.

In one embodiment, the content analysis engine 418 can include a processor and software modules. The processor can be a central processing unit (CPU), a microprocessor, a digital signal processor, or any other such device that can read and execute programming instructions. The software modules can include machine-executable instruction codes to be executed by the processor and can be stored in a machine-readable medium.

The content analysis engine 418 can inspect or analyze the contents of a communication session by linking all the packets of the communication session together. More specifically, the content analysis engine 418 can combine bodies of the packets in a communication session and examine the combined contents to measure readability, to analyze the communication information, to compare the contents to a predetermined character, etc. For example, the content analysis engine 418 can search whether an email communication contains certain keywords. As such, the content analysis engine 418 can perform a more complicated or comprehensive job than the firewall module 414.

In one embodiment, the primary unit 306 determines whether to transfer packets of a communication session to the content analysis engine 418 according to the policies, e.g., predefined by users. If the policies stipulate that a corresponding communication session needs to be content analyzed, packets of the communication session (e.g., distributed to the primary unit 306) can be transferred to the content analysis engine 418. The content analysis engine 418 inspects the contents of the communication session by linking all the packets in the same communication session together. After the inspection or analysis is completed, the content analysis engine 418 can send the multiple packets of the communication session to the TX/RX module 426, in one embodiment. The TX/RX module 426 forwards the packets of the communication session to the WAN switch 404. In contrast, if the policies stipulate that the corresponding communication session (e.g., distributed to the firewall unit 306) needs not to be content analyzed, the packets of the communication session can be transferred to the WAN switch 404 without going through the content analysis engine 418.

In one embodiment, if the first packet is unauthorized according to the filtering rules, e.g., the first packet belongs to an unauthorized communication session, the firewall module 414 can discard the first packet. In this circumstance, the session data set and the balance data set will not be generated. All the subsequent packets of the unauthorized communication session can be transferred to the firewall module 414 for filtering. Consequently, the firewall module 414 discards all the packets belonging to the unauthorized communication session, e.g., including the first packet and the subsequent packets, according to the filtering rules.

In one embodiment, the subordinate unit 316 includes a session database 432, a firewall module 434, a content analysis engine 438, a TX/RX modules 442 and 446, and a session module 444. The components in the subordinate unit 316 can be software modules stored in a machine-readable medium or hardware modules such as integrated circuits. The subordinate unit 316 can operate as a standalone firewall which is state-based, in one embodiment. The session database 432 stores multiple session data sets indicating multiple existing communication sessions respectively. The session module 444 has a session table which can also store the multiple session data sets.

When the TX/RX module 442 of the subordinate unit 316 receives a packet from the LAN switch 402, e.g., the first packet or the subsequent packet, the TX/RX module 442 sends the packet to the session module 444. The session module 444 compares the received packet to the session data sets in the session table stored thereof. If the received packet matches to one of the session data sets, the session module 444 determines that the received packet is a subsequent packet belonging to an existing communication session. Thus, the session module 444 selectively transfers the subsequent packet to the TX/RX module 446 or the content analysis engine 438 according to predetermined policies, e.g., set by users. If the policies stipulate that the corresponding communication session does not need to be content analyzed, the subsequent packet is transferred to the TX/RX module 446. The TX/RX module 446 can send the subsequent packet to the WAN switch 404. If the policies stipulate that the corresponding communication session needs to be content analyzed, the subsequent packet is transferred to the content analysis engine 438.

If the received packet does not match to any of the session data sets, the session module 444 can determine that the received packet is a first packet of a new communication session. Then, the session module 444 sends the first packet to the firewall module 434. The firewall module 434 can filter the first packet according to multiple filtering rules. If the first packet belongs to an authorized communication session, the firewall module 434 generates a new session data set indicating the corresponding communication session. The firewall module 434 stores the new session data set in the session database 432 and writes the session data set in the session table of the session module 444. Then, the firewall module 434 selectively sends the first packet to the TX/RX module 446 or the content analysis engine 438 according to the predetermined policies. If the policies stipulate that the corresponding communication session does not need to be content analyzed, the first packet is transferred to the TX/RX module 446. The TX/RX module 446 transfers the first packet to the WAN switch 404. If the policies stipulate that the corresponding communication session needs to be content analyzed, the firewall module 434 transfers the first packet to the content analysis engine 438.

The content analysis engine 438 analyzes the contents of a corresponding communication session by linking all the packets, e.g., including the first packet and the subsequent packets, of the same communication session together. After the content inspection or analysis is completed, the content analysis engine 438 transfers the packets to the TX/RX module 446, in one embodiment. The TX/RX module 446 can forward the packets to the WAN switch 404.

If the first packet belongs to an unauthorized communication session, the firewall module 434 discards the first packet without generating any session data set, in one embodiment. As a result, all the packets of the same communication session including the first packet and the subsequent packets can be filtered by the firewall module 434 and can be discarded if the communication session is unauthorized according to the filtering rules.

Accordingly, the traffic passing through the firewall cluster 350 can be distributed to different firewalls. For example, some communication sessions can be transferred to the content analysis engine 418 of the primary unit 306 for content analysis or inspection. Some other communication sessions can be transferred to the content analysis engine 438 of the subordinate unit 316 for content analysis or inspection. Therefore, the traffic can be balanced between the primary unit 306 and the subordinate unit 316, which can prevent one firewall from passing an inordinate amount of traffic.

Although the illustrative embodiment is described in relation to the firewalls, the present invention can be applied to other types of network devices that need to balance their traffic in a network.

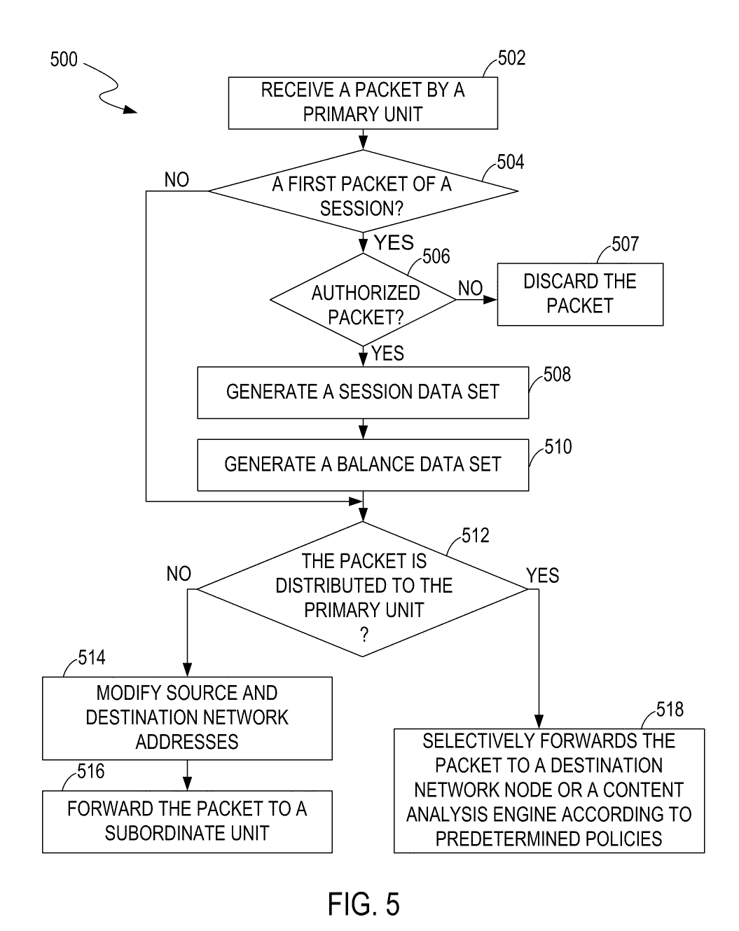

FIG. 5 illustrates a flowchart 500 of operations performed by the firewall cluster 350, in accordance with one embodiment of the present invention. FIG. 5 is described in combination with FIG. 3 and FIG. 4. Although specific steps are disclosed in FIG. 5, such steps are examples. That is, the present invention is well suited to performing various other steps or variations of the steps recited in FIG. 5.

In one embodiment, the firewall cluster 350 is operable for transferring multiple packets of a communication session from a source network node, e.g., the LAN switch 402, to a destination network node, e.g., the WAN switch 404. The firewall cluster 350 includes a primary unit having embedded load balance function, e.g., the primary unit 306, and a subordinate unit, e.g., the subordinate unit 316.

At step 502, the firewall cluster 350 receives a packet. In one embodiment, the firewall cluster 350 uses the network address, e.g., the MAC address, of the primary unit 306 as the virtual network address of the firewall cluster 350. As such, the packet is sent to the primary unit 306.

At step 504, the primary unit 306 determines whether the received packet is a first packet or a subsequent packet of a communication session. In one embodiment, multiple session data sets indicating multiple existing communication sessions are accessed. The received packet is compared to the session data sets to determine whether the packet is a first packet of a new communication session or a subsequent packet of an existing communication session. If the packet does not match to the session data sets, the primary unit 306 determines that the packet is the first packet. At step 506, the primary unit 306 filters the first packet according to multiple filtering rules. If the first packet is authorized, e.g., the first packet belongs to an authorized communication session, the primary unit 306 generates a session data set indicating the communication session based on the first packet at step 508. The primary unit 306 can further generate a balance data set indicating whether to distribute the first packet to the primary unit 306 or to the subordinate unit 316 at step 510. Then, the flowchart 500 goes to the step 512. If the first packet is unauthorized, e.g., the first packet belongs to an unauthorized communication session, at step 506, the primary unit 306 discards the first packet without generating the session data set and the balance data set at step 507.

At step 504, if the packet matches to one of the session data sets, the primary unit 306 determines that the packet is a subsequent packet of a corresponding existing communication session. Then, the flowchart 500 goes to the step 512.

At step 512, the packet, e.g., the first packet or the subsequent packet, is transferred according to the corresponding balance data set. If the corresponding balance data set indicates that the corresponding first packet is distributed to the primary unit 306, the packet is transferred by the primary unit 306 according to predetermined policies at step 518. For example, the packet is forwarded to the destination network node, e.g., the WAN switch 404, if the policies stipulate that the corresponding communication session does not need to be content analyzed. Otherwise, the primary unit 306 analyzes the contents of the corresponding communication session by linking all the packets of the same communication session together.

If the corresponding balance data set indicates that the communication session is distributed to the subordinate unit 316 at step 512, the source network address of the packet is changed to the network address of the primary unit 306 and the destination network address of the packet is changed to the network address of the subordinate unit 316 at step 514.

At step 516, the packet is transferred to the subordinate unit 316. The subordinate unit 316 compares the packet to multiple session data sets indicating multiple existing communication sessions. If the packet matches to one of the session data sets, e.g., the packet is a subsequent packet of an existing communication session, the packet is transferred by the subordinate unit 316 according to predetermined policies. For example, the subordinate unit 316 analyzes the contents of the corresponding communication session by linking all the packets of the same communication session together. Alternatively, the subordinate unit 316 forwards the subsequent packet to the destination network node.

If the packet does not match to any of the session data sets, e.g., the packet is a first packet of a new communication session at step 516, the subordinate unit 316 filters the packet according to multiple filtering rules. If the packet belongs to an authorized communication session, the packet can be transferred by the subordinate unit 316 according to the predetermined policies. For example, the first packet is sent to the content analysis engine 438 of the subordinate unit 316 for inspection or analysis by linking all the packets of the same communication session together. Alternatively, the subordinate unit 316 forwards the first packet to the destination network node. If the packet belongs to an unauthorized communication session, the packet is discarded by the subordinate unit 316.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention not limited to the foregoing description.

What is claimed is:

1. A network apparatus cluster for transferring a plurality of packets of a communication session to a network node, said network apparatus cluster comprising:
a primary unit operable for receiving said packets comprising a first packet and a plurality of subsequent packets, for generating a session data set indicating said communication session and a balance data set based on said first packet, and for determining that said subsequent packets belong to said communication session according to said session data set; and
a subordinate unit coupled to said primary unit,
wherein said balance data set indicates whether said first packet is distributed to said primary unit or said subordinate unit, and wherein said subsequent packets are transferred from said primary unit to said network node according to said balance data set.

2. The network apparatus cluster as claimed in claim 1, wherein said packets are transferred to said subordinate unit by changing a source network address of said packets to a network address of said primary unit and changing a destination network address of said packets to a network address of said subordinate unit.

3. The network apparatus cluster as claimed in claim 1, wherein said subordinate unit comprises:
a session module operable for receiving said packets if said balance data set indicates that said first packet is distributed to said subordinate unit; and
a firewall module coupled to said session module and operable for filtering said first packet according to a plurality of filtering rules,
wherein said packets are transferred from said subordinate unit to said network node if said first packet is authorized according to said filtering rules.

4. The network apparatus cluster as claimed in claim 1, wherein said subordinate unit comprises:
a session module operable for receiving said packets if said balance data set indicates that said first packet is distributed to said subordinate unit; and
a firewall module coupled to said session module and operable for filtering said packets according to a plurality of filtering rules, and for discarding said packets if said communication session is unauthorized according to said filtering rules.

5. The network apparatus cluster as claimed in claim 1, wherein said subordinate unit comprises:
a content analysis engine operable for analyzing contents of said communication session by linking said packets together if said balance data set indicates that said first packet is distributed to said subordinate unit.

6. The network apparatus cluster as claimed in claim 1, wherein said primary unit comprises:
a content analysis engine operable for analyzing contents of said communication session by linking said packets together if said balance data set indicates that said first packet is distributed to said primary unit.

7. The network apparatus cluster as claimed in claim 1, wherein said primary unit comprises a firewall module operable for filtering said first packet according to a plurality of filtering rules, and wherein said session data set and said balance data set are generated if said first packet is authorized according to said filtering rules.

8. The network apparatus cluster as claimed in claim 1, wherein said primary unit comprises a firewall module for filtering said packets according to a plurality of filtering rules, and for discarding said packets without generating said session data set and said balance data set if said communication session is unauthorized according to said filtering rules.

9. The network apparatus cluster as claimed in claim 1, wherein said primary unit comprises a session module having a session table for storing a plurality of session data sets indicating a plurality of communication sessions respectively, and operable for determining that said subsequent packets belong to said communication session by comparing said subsequent packets to said session data sets.

10. The network apparatus cluster as claimed in claim 1, wherein a virtual network address of said network apparatus cluster is a network address of said primary unit.

11. A method for transferring a plurality of packets of a communication session to a network node, said method comprising:
receiving said packets comprising a first packet and a plurality of subsequent packets by a primary unit;
generating a session data set and a balance data set based on said first packet by said primary unit, wherein said session data set indicates said communication session, and said balance data set indicates whether to distribute said first packet to said primary unit or a subordinate unit;
determining that said subsequent packets belong to said communication session according to said session data set by said primary unit; and
transferring said subsequent packets from said primary unit to said network node according to said balance data set.

12. The method as claimed in claim 11, further comprising:
changing a source network address of said packets to a network address of said primary unit; and
changing a destination network address of said packets to a network address of said subordinate unit so as to transfer said packets to said subordinate unit.

13. The method as claimed in claim 11, further comprising:
transferring said subsequent packets to said subordinate unit if said balance data set indicates that said first packet is distributed to said subordinate unit;
filtering said first packet by said subordinate unit according to a plurality of filtering rules; and
transferring said packets from said subordinate unit to said network node if said first packet is authorized according to said filtering rules.

14. The method as claimed in claim 11, further comprising:
transferring said subsequent packets to said subordinate unit if said balance data set indicates that said first packet is distributed to said subordinate unit;
filtering said packets by said subordinate unit according to a plurality of filtering rules; and
discarding said packets by said subordinate unit if said communication session is unauthorized according to said filtering rules.

15. The method as claimed in claim 11, further comprising:
filtering said first packet by said primary unit according to a plurality of filtering rules; and
generating said session data set and said balance data set if said first packet is authorized according to said filtering rules.

16. The method as claimed in claim 11, further comprising:
filtering said packets by said primary unit according to a plurality of filtering rules; and
discarding said packets by said primary unit without generating said session data set and said balance data set if said communication session is unauthorized according to said filtering rules.

17. The method as claimed in claim 11, further comprising:
using a network address of said primary unit as a virtual network address of a network apparatus cluster.

18. The method as claimed in claim 11, further comprising:
accessing a plurality of session data sets indicating a plurality of communication sessions; and
comparing said subsequent packets to said session data sets to determine that said subsequent packets belong to said communication session.

19. The method as claimed in claim 11, further comprising:
analyzing contents of said communication session by said primary unit by linking said packets together if said balance data set indicates that said first packet is distributed to said primary unit.

20. The method as claimed in claim 11, further comprising:
analyzing contents of said communication session by said subordinate unit by linking said packets together if said balance data set indicates that said first packet is distributed to said subordinate unit.

21. A network apparatus comprising:
a session module operable for transferring a plurality of packets of a communication session, wherein said packets comprise a first packet and a second packet;
a firewall module coupled to said session module and operable for generating a session data set indicating said communication session based on said first packet; and
a load balance module coupled to said firewall module and to said session module and operable for generating a balance data set indicating load balancing of said communication session based on said first packet,
wherein said session module determines that said second packet belongs to said communication session according to said session data set and transfers said second packet according to said balance data set.

22. The network apparatus as claimed in claim 21, wherein said firewall module is further operable for filtering said first packet according to a plurality of filtering rules, and wherein said session data set and said balance data set are generated if said communication session is authorized according to said filtering rules.

23. The network apparatus as claimed in claim 21, wherein said firewall module is further operable for filtering said first packet according to a plurality of filtering rules, and wherein said first packet is discarded without generating said session data set and said balance data set if said communication session is unauthorized according to said filtering rules.

24. The network apparatus as claimed in claim 21, wherein said session module comprises a session table for storing said session data set, and wherein said session module identifies said second packet by comparing said second packet to said session data set stored in said session table.
